(19) United States
(12) Patent Application Publication
(10) Pub. No.: US 2026/0034782 A1
(43) Pub. Date: Feb. 5, 2026

(54) LIQUID EJECTION HEAD AND METHOD FOR MANUFACTURING SAME

(71) Applicant: CANON KABUSHIKI KAISHA, Tokyo (JP)

(72) Inventors: TAKAYUKI KAMIMURA, Kanagawa (JP); MICHIKO JOHNSON, Tokyo (JP); MANABU OTSUKA, Kanagawa (JP)

(21) Appl. No.: 19/256,987

(22) Filed: Jul. 1, 2025

(30) Foreign Application Priority Data
Aug. 5, 2024 (JP) 2024-128952

(51) Int. Cl. B41J 2/14; B41J 2/16

(52) U.S. Cl. CPC B41J 2/14129; B41J 2/14072; B41J 2/1634

(57) ABSTRACT

A liquid ejection head is used which has: a substrate provided with an ejection port for a liquid, an energy generating element for generating an energy for ejecting the liquid, a liquid inflow port for receiving supply of the liquid, a pad electrode, and an internal wire for connecting the pad electrode and the energy generating element; and an external wire connected to the pad electrode of the substrate, wherein. a depressed portion is provided on the side surface of the substrate, and at least the pad electrode, a partial region. which is closer to the pad electrode, and the region, which includes the depressed portion of the side surface of the substrate, of the external wire are sealed with a resin sealing agent.

### BACKGROUND

### Field of the Technology

The present disclosure relates to a liquid ejection head and a method for manufacturing the same.

### Description of the Related Art

A liquid ejection device is known that includes a liquid ejection head for supplying energy to a liquid such as an ink in a liquid chamber, and ejecting the liquid to outside through an ejection port. An external wire for applying an electric signal to an element substrate from outside of the liquid ejection head is electrically connected to such a liquid ejection head. In Japanese Patent Application Laid-Open No. 2021-28133, a resin sealing agent for improving electrical insulation is disposed between the side surface of the element substrate of the liquid ejection head and the external wires.

### SUMMARY

The present disclosure provides a liquid ejection head comprising:
a substrate provided with an ejection port configured to eject a liquid; an energy generating element configured to generate an energy for ejecting the liquid, a liquid inflow port configured to receive supply of the liquid; a pad electrode, and an internal wire configured to electrically connect the pad electrode and the energy generating element;
an external wire connected to the pad electrode of the substrate; and
a sealing agent covering an electrical connection portion connecting the pad electrode and the external wire,
wherein
a depressed portion is provided on a side surface of the substrate, and the sealing agent enters the depressed portion to cover at least a part of the side surface of the substrate.

The present disclosure also provides a method for manufacturing a liquid ejection head having a substrate and an external wire, the method comprising:
forming a substrate having an ejection port configured to eject a liquid; an energy generating element configured to generate an energy for ejecting the liquid, a liquid inflow port configured to receive supply of the liquid; a pad electrode, an internal wire configured to electrically connect the pad electrode, the energy generating element, and a depressed portion provided on a side surface;
connecting the external wire to the pad electrode of the substrate; and
covering with a sealing agent an electrical connection portion connecting the pad electrode and the external wire, and at least a portion of the side surface of the substrate including the depressed portion.

Features of the present disclosure will become apparent from the following description of embodiments with reference to the attached drawings. The following description of embodiments are described by way of example.

### BRIEF DESCRIPTION OF THE DRAWINGS

FIG. 1 is a cross sectional view illustrating an example of a liquid ejection element substrate according to First Embodiment.

FIGS. 2A to 2E are each a cross sectional view illustrating an example of a liquid ejection element substrate according to First Embodiment.

FIG. 3 is a cross sectional view illustrating an example of a liquid ejection element substrate according to Second Embodiment.

FIGS. 4A to 4C are each a cross sectional view illustrating an example of a step of a liquid ejection element substrate according to Second Embodiment.

FIG. 5 is a cross sectional view illustrating an example of a liquid ejection element substrate according to Third Embodiment.

FIGS. 6A to 6C are each a cross sectional view illustrating an example of a step of a liquid ejection element substrate according to Third Embodiment.

FIGS. 7A to 7C are each a cross sectional view illustrating an example of a liquid ejection element substrate according to Fourth Embodiment.

FIGS. 8A to 8C are each a cross sectional view illustrating an example of a step of a liquid ejection element substrate according to Fourth Embodiment.

FIGS. 9A and 9B are each a cross sectional view illustrating an example of a liquid ejection element substrate according to Fifth Embodiment.

FIGS. 10A to 10C are each a cross sectional view illustrating an example of a step of a liquid ejection element substrate according to Fifth Embodiment.

FIG. 11 is a cross sectional view illustrating an example of a liquid ejection element substrate according to Sixth Embodiment.

FIGS. 12A and 12B are plan views each showing an example of a liquid ejection element substrate according to Sixth Embodiment.

FIGS. 13A and 13B are each a view illustrating the configuration of the liquid ejection element substrate.

FIGS. 14A and 14B are views illustrating the wiring of the liquid ejection element substrate.

FIG. 15 is a view illustrating the configuration of the liquid ejection head.

FIG. 16 is a cross-sectional view showing an example of a conventional liquid ejection element substrate.

### DESCRIPTION OF THE EMBODIMENTS

Below, preferred embodiments of the present disclosure will be described in detail with reference to the accompanying drawings. However, the dimensions, materials, shapes, and relative arrangements of the constituent components described in the embodiments are, not intended to limit the scope of the present disclosure only thereto unless otherwise specified. Further, the materials, shapes, and the like regarding the members described once in the following description are the same as those in the initial description in the subsequent description unless otherwise specified. Well-known technologies or known technologies in the present field can be applied to configurations and steps that are not specifically shown or described. In addition, the present disclosure is not limited only to the embodiments, and all the combinations of features described in the embodiments are not necessarily essential to the solving means of the present disclosure.

According to the study by the present inventors, in a liquid ejection head, improvement of the adhesiveness of a resin sealing agent disposed between the side surface of the element substrate and the external wire is required from the viewpoint of extension of the life. In a liquid ejection head, it is required to improve adhesiveness of the resin sealing agent provided on the side surface of an element substrate.

### Configuration of Liquid Ejection Head

First, the basic configuration of a liquid ejection head 150 will be described. The technology of the present disclosure can be applied to a liquid ejection element substrate (recording element substrate) to be used in an inkjet type liquid ejection head (recording head) that applies an energy to a liquid such as an ink, thereby ejecting the liquid, and causing the liquid to be deposited on a recording medium such as paper to form an image. The technology of the present disclosure is also grasped as a liquid ejection device (recording device) using such a liquid ejection head, and a method for manufacturing the liquid ejection head or the liquid ejection device.

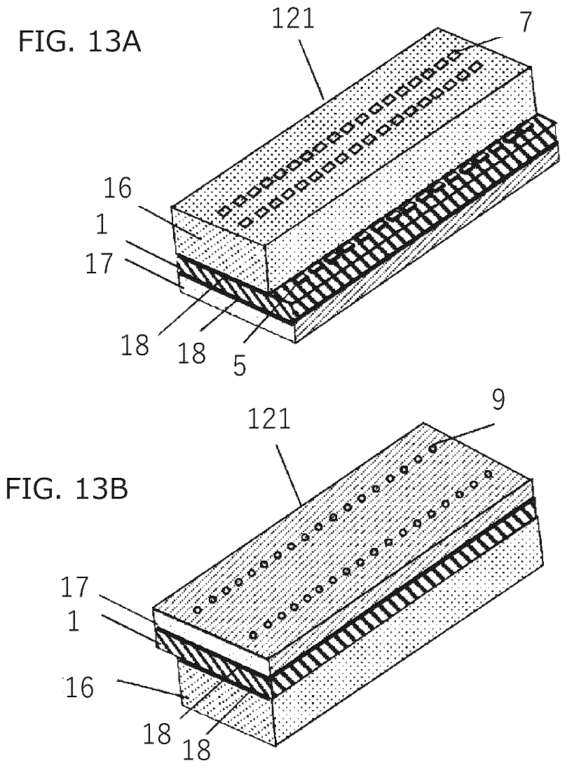

FIG. 13A is a schematic view showing a liquid ejection element substrate 121 with the side of the liquid inflow port 7 as the upper surface. FIG. 13B is a schematic view showing the liquid ejection element substrate 121 with the side of the liquid ejection port 9 as the upper surface. The liquid ejection element substrate 121 of FIG. 13A has a structure in which a first substrate 1, a second substrate 17, and a third substrate 16 are joined and stacked by a junction layer 18. Incidentally, although an example in which three substrates are joined has been shown here, the structure of the electrode 5 and the method for connection with an external wiring substrate 4 can assume the same configuration also when other number of (e.g., two) substrates have been joined.

The first substrate 1 functions as a liquid passage substrate provided with a liquid passage 8 and a pressure chamber 15. The first substrate 1 is also provided with an electrode 5 (pad electrode), also referred to as a PAD, for receiving supply of electric power and an ejection drive signal from the outside. The second substrate 17 functions as a liquid ejection substrate provided with a plurality of liquid ejection ports 9. The third substrate 16 is provided with a plurality of liquid inflow ports 7 for guiding the liquid from a tank or the like not shown to the pressure chamber 15, and is provided with an energy generating element 3 for generating an energy for ejecting the liquid from the liquid ejection port 9, and functions as an energy generating substrate.

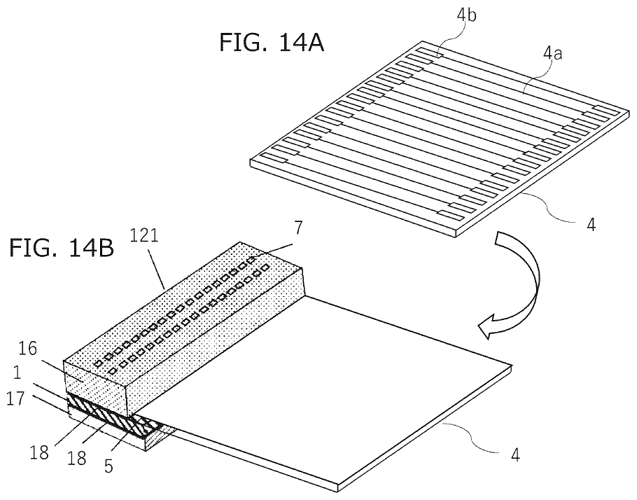

FIGS. 14A and 14B are schematic views for showing the state in which the liquid ejection element substrate 121 and the external wiring substrate 4, which is an electric wiring substrate, are connected, as viewed from the same direction as in FIG. 13A. As shown in FIG. 14A, an external wire 4a provided with a lead part 4b is arranged on one surface (wiring surface) of the external wiring substrate 4. Desired metal wires and terminals can be used for the external wires 4a and the lead parts 4b. Such an external wiring substrate 4 is installed on the liquid ejection element substrate 121 so that the plurality of lead parts 4b may face the plurality of electrodes 5, respectively, and is metal-joined by a method such as ultrasonic wave or thermo-compression bonding. FIG. 14B shows a state in which the non-wired surface of the external wiring substrate 4 is visible. Incidentally, the method for electrically connecting the external wiring substrate 4 and the liquid ejection element substrate 121 is not limited to this method, and for example, wire bonding or bump bonding may be used. This electrical connection part is sealed with a resin sealing agent, as described later, and is protected from external stimulation of a liquid, or the like.

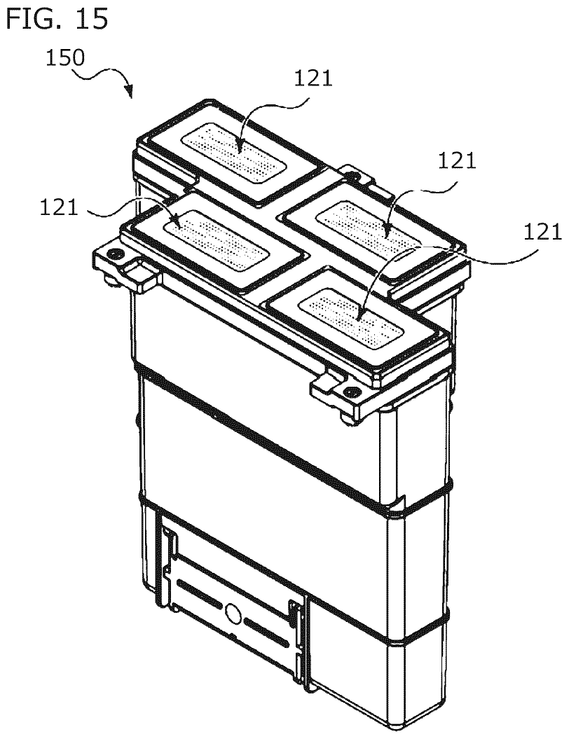

FIG. 15 shows an example of the configuration of a liquid ejection head 150 using the liquid ejection element substrate 121. The liquid ejection head 150 shown in FIG. 15 includes a plurality of liquid ejection element substrates 121. While the liquid ejection head 150 of FIG. 15 is configured to be supplied with a liquid from a liquid tank for accommodating the liquid, the present disclosure can also be preferably used for a liquid ejection head integral with the liquid tank. In addition, the liquid ejection head may be the one that is applied to a serial recording system that ejects a liquid while operating, or additionally to the one having nozzles over a range corresponding to the full width of the recording medium as being applied to a line printer.

### Conventional Configuration

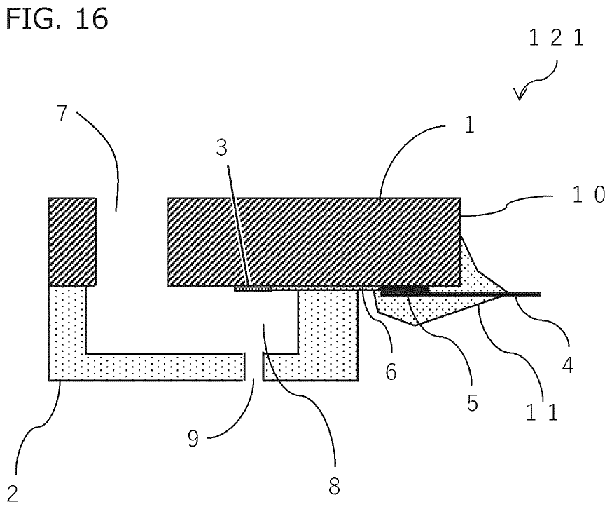

FIG. 16 is a view showing an example of a conventional liquid ejection element substrate 121. The conventional liquid ejection element substrate 121 includes a first substrate 1 and a liquid passage forming material 2. The liquid passage forming material can also be said as the second substrate in the present embodiment.

The first substrate 1 has an energy generating element 3 for generating a liquid ejection energy, an electrode 5 for applying an electric signal from the external wiring substrate 4, a wire 6 (internal wire) for electrically connecting the electrode 5, and the energy generating element 3, and a liquid inflow port 7. The liquid passage forming material 2 has a liquid ejection port 9 for ejecting a liquid, and a liquid passage 8 for communicating the liquid inflow port 7 with the liquid ejection port 9.

A resin sealing agent 11 for sealing the electrodes 5 and the external wires 4a from the outside of the element substrate is arranged on a chip side surface 10 when the first substrate 1 has been singulated into chips from a wafer state by dicing. The resin sealing agent 11 is arranged in a gap between the liquid ejection element substrate 121 and the external wiring substrate 4 by causing the fluid resin sealing agent 11 to flow, and pouring the resin sealing agent 11. Thereafter, the resin sealing agent 11 is formed into a constant shape by surface tension, and is solidified by a heat treatment, or the like. However, when the chip side surface 10 is a chip cut surface and is formed in a flat surface, the adhesion force between the chip side surface 10 and the resin sealing agent 11 may be reduced, and the resin sealing agent 11 may be peeled off to impair the electrical insulation.

### First Embodiment

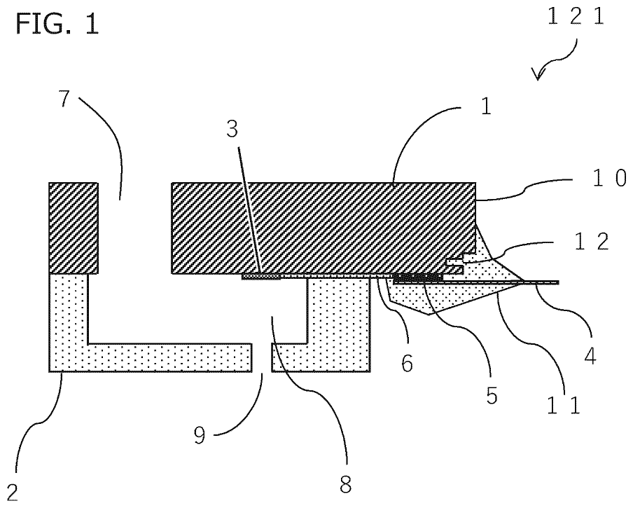

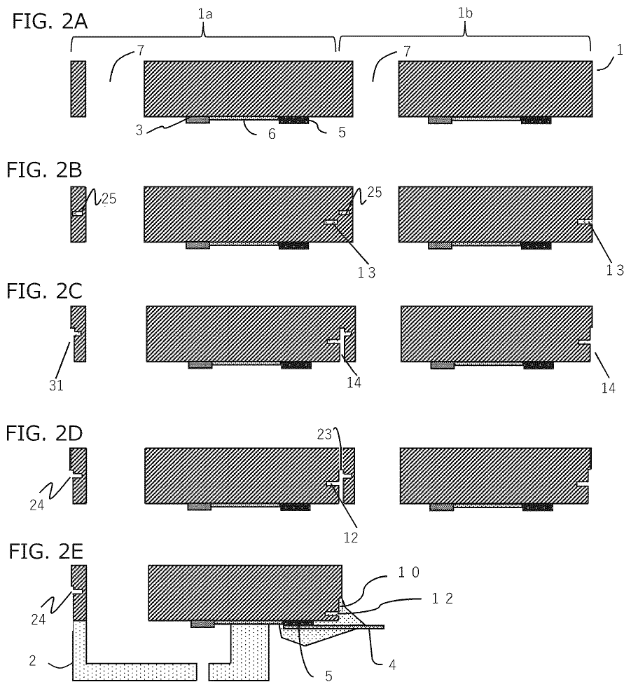

First Embodiment will be described with reference to FIG. 1 and FIGS. 2A to 2E.

As shown in FIG. 1, in the liquid ejection element substrate 121 of the present embodiment, a depressed portion 12 is formed in the vicinity of a connection portion with the resin sealing agent 11 in the chip side surface 10 of the first substrate 1. As a result of this, when the fluid resin sealing agent 11 is poured thereinto, the resin sealing agent 11 is drawn into the depressed portion 12 by capillarity. As a result of the resin sealing agent 11 that has thus entered the depressed portion 12, the contact area between the resin sealing agent 11 and the chip side surface 10 increases, and hence the adhesion force between the chip side surface 10 and the resin sealing agent 11 is improved.

FIGS. 2A to 2E show a method for manufacturing the liquid ejection element substrate 121 of the present embodiment. First, as shown in FIG. 2A, the first substrate 1 on which the liquid inflow port 7, the energy generating element 3, the wires 6, and the electrodes 5 is formed is prepared. The first substrate 1 is, for example, a silicon substrate. The energy generating element 3 is, for example, a heating resistor, and is formed by deposition and etching. However, a piezoelectric element, or the like may be used as the energy generating element 3. Further, the electrodes 5 and the wires 6 can also be formed by metal deposition, etching, and the like. Incidentally, a protective film may be further provided on these members. The liquid inflow port 7 is an opening for receiving the supply of a liquid such as an ink from the outside (for example, a liquid accommodation portion or an external tank in the head), and supplying the liquid to a passage communicating to the liquid ejection port 9, and is formed, for example, by etching. The left side portion (reference numeral and sign 1a) and the right side portion (reference numeral and sign 1b) in FIG. 2A each become the first substrate 1 to be used for different liquid ejection element substrates 121 after dicing.

Subsequently, as shown in FIG. 2B, a modified layer 13 and a passage side modified layer 25 are formed on the first substrate 1 using a laser. The modified layer 13 is formed at a position to be a chip side surface 10 when the first substrate 1 in a wafer state is singulated into chips by dicing. The modified layer 13 will become a depressed portion 12 later. Although the passage side modified layer 25 is not essential, by providing it, the passage side depressed portion 24 is also formed on the side surface opposite to the side where the depressed portion 12 is formed, and the adhesion force when the liquid ejection element substrate 121 is bonded to a separate member can be enhanced. Incidentally, the formation of the liquid inflow port 7 may be performed after the formation of the modified layer 13.

Subsequently, as shown in FIG. 2C, a chip end groove 14 is formed at a position continuous from the modified layer 13 by dry etching using a resist mask. Note that the chip end groove 14 may be formed by laser machining. Similarly, a passage side chip end groove 31 is formed at a position continuous from the passage side modified layer 25. The depth of the chip end groove 14 is at least a depth reaching the modified layer 13, and may be equal to or greater than the depth of the modified layer 13.

Subsequently, as shown in FIG. 2D, the modified layer 13 is removed, thereby to form a depressed portion 12 on the chip side surface 10. The depressed portion 12 was formed with a depth of 30 μm from the chip side surface 10. For the removal of the modified layer 13, a method such as a chemical treatment using, for example, TMAH (tetramethylammonium hydroxide) can be used. Similarly, the passage side modified layer 25 is also removed, thereby to form a passage side depressed portion 24.

Subsequently, as shown in FIG. 2E, a liquid passage forming material 2 is deposited on the surface on which the energy generating element 3 and the wires 6 are provided of both surfaces of the first substrate 1, and a liquid passage 8 communicating with the liquid inflow port 7 is formed by etching or the like. Then, the first substrate 1 is cut along the dicing line 23 to obtain a single liquid ejection element substrate 121. Any method such as blade dicing can be adopted as the dicing method. Then, the electrode 5 and the external wiring substrate 4 are connected, and the resin sealing agent 11 is applied to the periphery of the connection portion or the chip side surface 10 including the depressed portion 12. As a result, the liquid ejection element substrate 121 shown in FIG. 1 can be manufactured. The resin sealing agent 11 is applied to at least the electrode 5 and a partial region of the external wire closer to the electrode 5. In the liquid ejection element substrate 121 thus obtained, the adhesiveness is improved by drawing the resin sealing agent 11 into the depressed portion 12, peeling and erosion due to a liquid of the substrate are prevented, and the effect of extending the life of the liquid ejection element substrate 121 and the liquid ejection head 150 is obtained.

### Second Embodiment

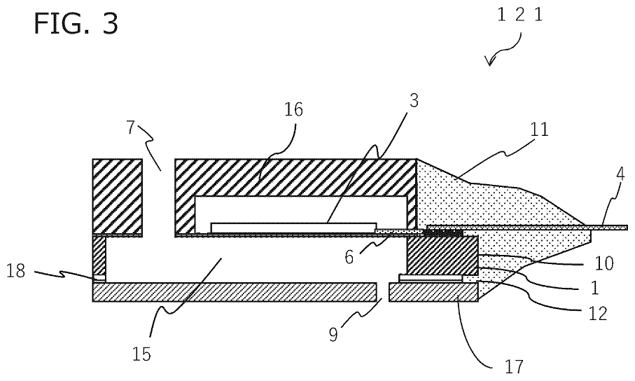

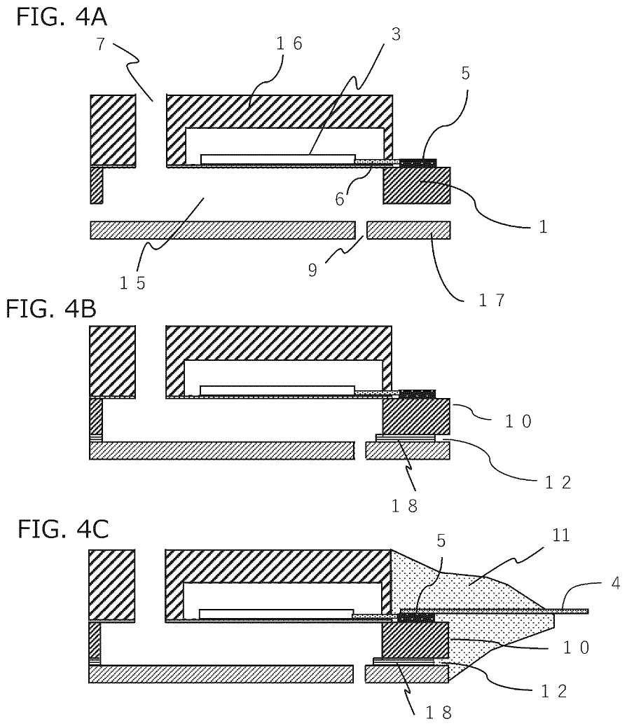

Second Embodiment will be described with reference to FIG. 3 and FIGS. 4A to 4C. The description on the same configurations as those in the First Embodiment will be omitted.

FIG. 3 is a cross sectional view of the liquid ejection element substrate 121 obtained in the present embodiment. As with the First Embodiment, the depressed portion 12 is formed in the chip side surface 10, which improves the adhesiveness between the resin sealing agent 11 and the chip side surface 10.

As shown in FIG. 4A, the liquid ejection element substrate 121 of the present embodiment has a structure including three layers of a first substrate 1, a second substrate 17, and a third substrate 16. An energy generating element 3, a wire 6, an electrode 5, and a pressure chamber 15 are formed on the first substrate 1. A liquid inflow port 7 is formed in the third substrate 16. The first substrate 1 and the third substrate 16 are joined to configure a joined substrate. A liquid ejection port 9 is formed on the second substrate 17. Incidentally, the liquid inflow port 7 and the liquid ejection port 9 may be formed later. The energy generating element 3 provided on the surface of the first substrate 1 opposite to the liquid ejection port 9 is arranged so as to face a depressed portion provided on the third substrate 16.

Subsequently, as shown in FIG. 4B, the first substrate 1 and the second substrate 17 are joined using the junction layer 18, which is an adhesive. After arranging the junction layer 18, the first substrate 1 and the second substrate 17 are joined, and the joined substrates are heated and pressurized under vacuum. As a result of this, the adhesive is drawn into the pressure chamber 15 at the position of the junction part of the chip side surface 10. As a result, the depressed portion 12 is formed at a position where the chip side surface 10 should be formed when the joined substrate is singulated into chips by dicing from the wafer state. The depressed portion 12 of the present embodiment was formed so as to have a depth of 30 μm or more from the chip side surface 10.

Subsequently, as shown in FIG. 4C, the three-layer joined wafer-state joined substrate is singulated into chips by dicing. Then, the electrode 5 and the external wiring substrate 4 are electrically connected, and the resin sealing agent 11 is applied to the chip side surface 10 including the periphery of the connection portion and the depressed portion 12. As a result, the liquid ejection element substrate 121 shown in FIG. 3 is obtained. That is, the depressed portion 12 in the present embodiment is a portion where the junction layer 18 is more depressed than the end surface of the first substrate 1 and the end surface of the second substrate 17 on the side surface of the chip. Incidentally, with the method of the present embodiment, it becomes unnecessary to provide a modified layer or to provide a groove by laser machining.

### Third Embodiment

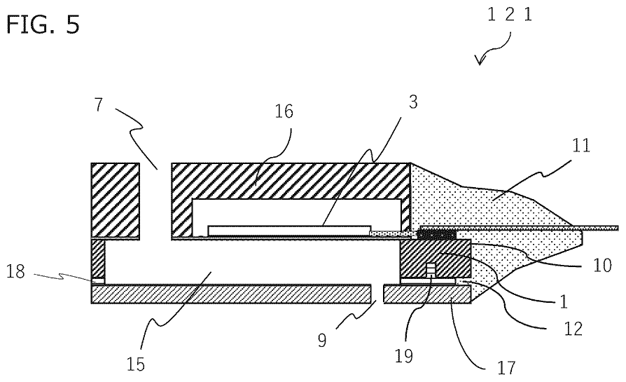

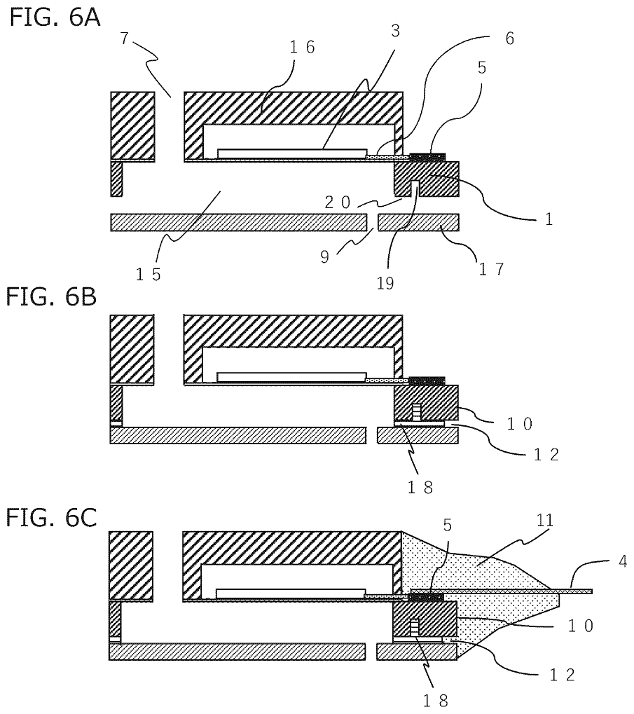

Third Embodiment will be described with reference to FIG. 5 and FIGS. 6A to 6C. The description on the same configurations as those in the respective embodiments will be omitted.

FIG. 5 is a cross sectional view of the liquid ejection element substrate 121 obtained in the present embodiment. Since the depressed portion 12 is formed in the chip side surface 10, the adhesiveness between the resin sealing agent 11 and the chip side surface 10 is improved. Further, a junction surface depressed portion 19 is provided in a portion of the first substrate 1 where an adhesive is applied for joining with the second substrate 17.

As shown in FIG. 6A, at the first substrate 1, an energy generating element 3, a wire 6, an electrode 5, and a pressure chamber 15 are formed as in the First Embodiment, Further, in the first substrate 1 of the present embodiment, the junction surface depressed portion 19 to serve as an adhesive escape groove is formed at an intermediate position between the position of the chip side surface 10 and the position of the pressure chamber 15, of the junction surface 20 with the second substrate 17. The second substrate 17 and the third substrate 16 are similar to those in the First Embodiment.

Subsequently, as shown in FIG. 6B, the first substrate 1 and the second substrate 17 are joined using the junction layer 18, which is an adhesive. At this step, the adhesive is drawn into the junction surface depressed portion 19, thereby forming the depressed portion 12 at a position to be the chip side surface 10 when the joined substrate is singulated into chips from the wafer state by dicing. The depressed portion 12 of the present embodiment was formed so as to have a depth of 30 μm or more from the chip side surface 10. The adhesive is filled in at least a part of the junction surface depressed portion 19.

Subsequently, as shown in FIG. 6C, the liquid ejection element substrate 121 shown in FIG. 5 is obtained by performing dicing and resin sealing in the same manner as in the First Embodiment. Incidentally, also in the method of the present embodiment, it is not necessary to form a modified layer or a groove.

### Fourth Embodiment

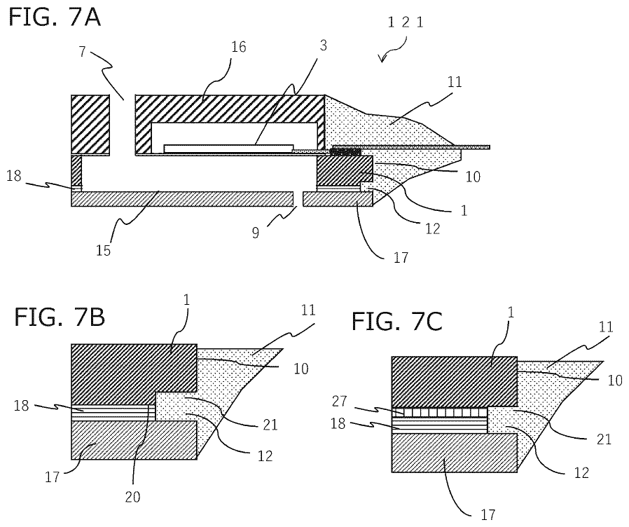

Fourth Embodiment will be described with reference to FIGS. 7A to 7C and

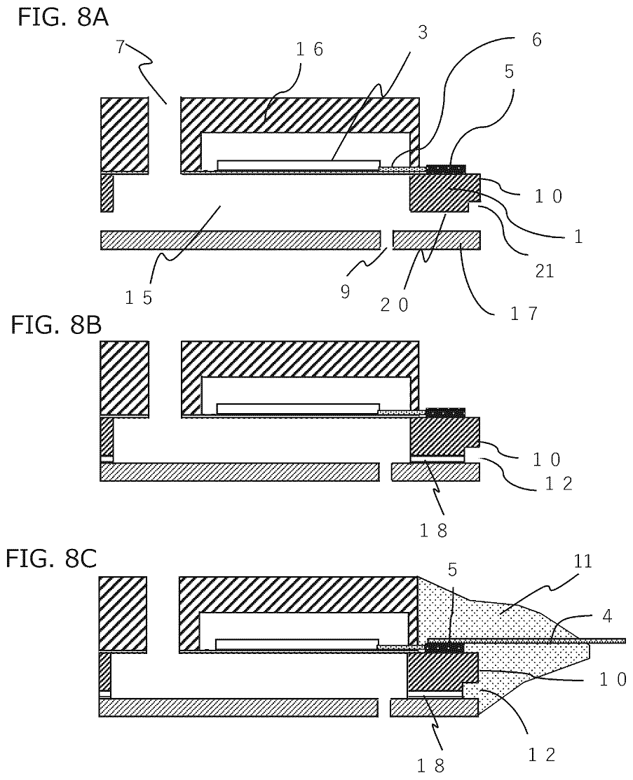

FIGS. 8A to 8C. The description on the same configurations as those in the respective embodiments will be omitted.

FIG. 7A is a cross sectional view of the liquid ejection element substrate 121 obtained in the present embodiment. Since the depressed portion 12 is formed in the chip side surface 10, the adhesiveness between the resin sealing agent 11 and the chip side surface 10 is improved. FIGS. 7B and 7C are enlarged cross sectional views of the vicinity of the depressed portion 12 in the liquid ejection element substrate 121 according to each Modified Example of the present embodiment. As shown in FIGS. 7B and 7C, the liquid ejection element substrate 121 of the present embodiment has a step portion 21 continuous to the depressed portion 12 provided in the layer corresponding to the junction layer 18. The step portion 21 can be said to be a step-shaped portion provided at the end of the first substrate 1.

As shown in FIG. 8A, at the first substrate 1, an energy generating element 3, a wire 6, an electrode 5, and a pressure chamber 15 are formed as in the First Embodiment. Further, in the first substrate 1 of the present embodiment, a step portion 21 is formed at a position where the junction surface 20 and the chip side surface 10 cross each other. The step portion 21 can be formed by an arbitrary method such as etching. The second substrate 17 and the third substrate 16 are similar to those in the First Embodiment.

Subsequently, as shown in FIG. 8B, the first substrate 1 and the second substrate 17 are joined using the junction layer 18, which is an adhesive. At this time, since the step portion 21 is wide enough not to cause capillarity, the adhesive will not fill the step portion 21. As a result, the depressed portion 12 is formed at a position to be the chip side surface 10 when the joined substrate in the wafer state is singulated into chips by dicing. The depressed portion 12 was formed so as to have a depth of 30 μm or more from the chip side surface 10.

Note that, as shown in FIG. 7C, the step portion 21 can also be formed by providing a formation film 27 of an arbitrary material on the junction surface 20 of the first substrate 1 and then removing the formation film 27 at a portion where the depressed portion 12 is to be formed.

Further, the step portion 21 may be formed on the side of the second substrate 17. Also in that case, the step portion 21 may be formed by etching or the like, or the formation film 27 may be provided on the second substrate 17.

Subsequently, as shown in FIG. 8C, dicing and resin sealing are performed in the same manner as with the First Embodiment. At this step, the depressed portion 12 and the step portion 21 continuously form a recess portion having a shape depressed from the chip side surface 10. Then, the applied resin sealing agent 11 enters the recess portion, thereby to increase the contact area between the chip side surface 10 and the resin sealing agent 11, resulting in an improved adhesion force. As a result of this, the liquid ejection element substrate 121 shown in FIG. 7A is obtained.

### Fifth Embodiment

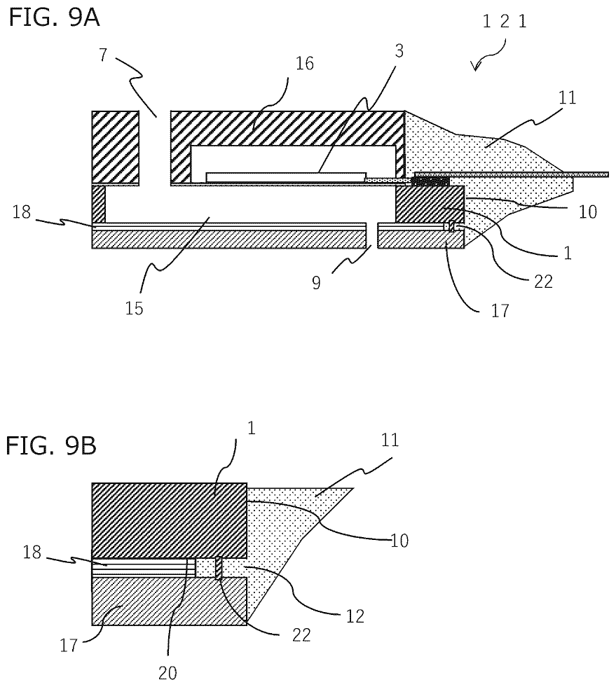

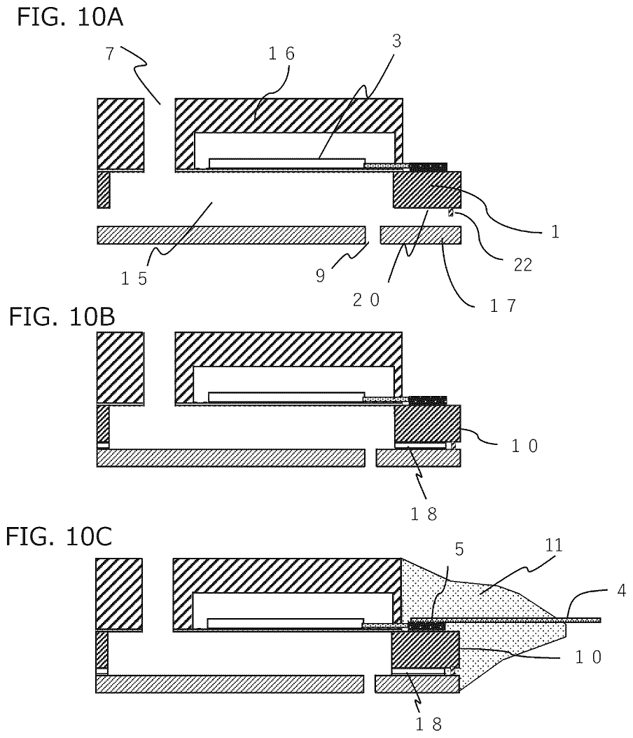

Fifth Embodiment will be described with reference to FIGS. 9A and 9B and FIGS. 10A to 10C. The description on the same configurations as those in the respective embodiments will be omitted.

FIG. 9A is a cross sectional view of the liquid ejection element substrate 121 obtained in the present embodiment. Since the protruded portions 22 are provided on the first substrate 1, the resin sealing agent 11 is drawn into the inside of the substrate from the chip side surface 10, and the adhesiveness between the resin sealing agent 11 and the chip side surface 10 is improved. FIG. 9B is an enlarged cross sectional view of the vicinity of the protruded portion 22.

As shown in FIG. 10A, at the first substrate 1, an energy generating element 3, a wire 6, an electrode 5, and a pressure chamber 15 are formed as with the First Embodiment, Further, in the first substrate 1 of the present embodiment, a protruded portion 22 protruding in a direction toward the second substrate 17 is formed on the junction surface 20. The second substrate 17 and the third substrate 16 are similar to those in the First Embodiment. Incidentally, the protruded portion 22 may be formed so as to protrude from the second substrate 17 to the junction surface 20 of the first substrate 1. The protruded portion 22 may be formed by processing the first substrate 1 or the second substrate 17, or may be formed of a separate member. The protruded portion 22 is a protruded portion provided on one of the two joined substrates and protruding toward the other. The protruded portions 22 are required to be provided on at least one substrate and may be provided on both.

Subsequently, as shown in FIG. 10B, the first substrate 1 and the second substrate 17 are joined using the junction layer 18, which is an adhesive. The joining may be performed in the atmosphere or under vacuum. Here, as shown in FIG. 9B, the presence of the protruded portion 22 creates a distance between the surface of the first substrate 1 and the surface of the second substrate 17. Then, a gap is generated in the periphery of the protruded portion 22, so that a depressed portion 12 is formed. The protruded portion 22 was provided at a position 15 μm from the chip side surface 10. Further, the depressed portion 12 was formed so as to have a depth of 30 μm or more from the chip side surface 10.

Subsequently, as shown in FIG. 10C, dicing and resin sealing are performed in the same manner as with the First Embodiment. As a result of this, the liquid ejection element substrate 121 shown in FIG. 9A is obtained.

### Sixth Embodiment

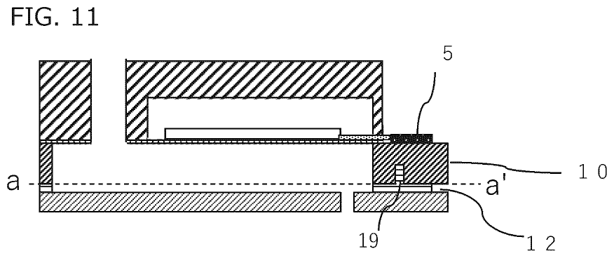

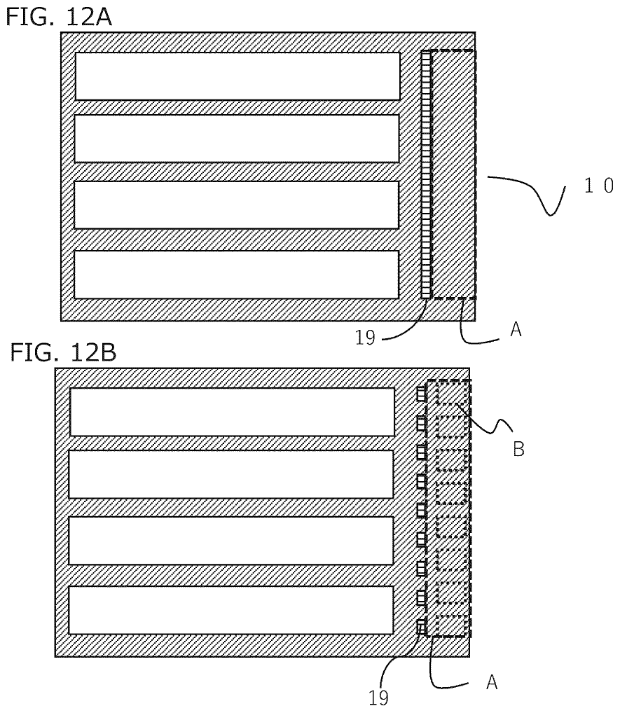

Sixth Embodiment will be described with reference to FIG. 11 and FIGS. 12A and 12B. The description on the same configurations as those in the respective embodiments will be omitted.

In the Third Embodiment, the depressed portion 12 was formed by providing the junction surface depressed portion 19 in the first substrate 1 and drawing the resin sealing agent 11 thereinto. Here, as shown in the cross sectional view of FIG. 11 and the a-a′ top view of FIG. 12A, when the adhesive is completely filled in the junction surface depressed portion 19 as the adhesive escape groove, the resin sealing agent 11 becomes unable to be drawn in more amount. For this reason, it is preferable to form the substrate so as to satisfy the relationship of α22 β, where α represents the capacitance of the junction surface depressed portion 19, and α represents the capacitance of the adhesive in the region A between the junction surface depressed portion 19 and the chip side surface 10.

FIG. 12B is a plan view of the case where the junction surface depressed portions 19 are not formed continuously. The plurality of junction surface depressed portions 19 are arranged in plural numbers along the same direction as the direction of extension of the chip side surface 10. In this case, it is preferable to form the chip so as to satisfy α′>α′, where α′ represents the total capacitance of the plurality of junction surface depressed portions 19, and β′ represents the adhesive capacitance of the region A between the straight line connecting the junction surface depressed portions 19 and the chip side surface 10.

In the case having the plurality of junction surface depressed portions 19, for the arrangement of each of the plurality of junction surface depressed portions 19, the depressed portion 12 is preferably formed on the chip side surface 10 facing the electrode 5 because it is more required to suppress peeling of the resin sealing agent 11 on the chip side surface 10 facing the electrode 5. Thus, it is preferable that each of the plurality of junction surface depressed portions 19 is disposed on a straight line connecting the position B of the electrode 5 and the chip side surface 10 or on an extension line thereof. Further, also in the case having the continuous junction surface depressed portions 19, similarly, it is preferable to form the depressed portion 12 on the chip side surface 10 facing the electrode 5.

According to the present disclosure, in a liquid ejection head, the adhesiveness of a resin sealing agent provided on a side surface of an element substrate is improved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-128952, filed Aug. 5, 2024, which is hereby incorporated by reference herein in its entirety.

What is claimed is:

1. A liquid ejection head comprising:
a substrate provided with an ejection port configured to eject a liquid; an energy generating element configured to generate an energy for ejecting the liquid, a liquid inflow port configured to receive supply of the liquid; a pad electrode, and an internal wire configured to electrically connect the pad electrode and the energy generating element;
an external wire connected to the pad electrode of the substrate; and
a sealing agent covering an electrical connection portion connecting the pad electrode and the external wire,
wherein
a depressed portion is provided on a side surface of the substrate, and the sealing agent enters the depressed portion to cover at least a part of the side surface of the substrate.

2. The liquid ejection head according to claim 1, wherein
the substrate includes a first substrate and a second substrate joined with the first substrate by a junction layer,
the sealing agent is disposed so as to cover a junction part between the first substrate and the second substrate, and
the depressed portion is a portion in which the junction layer is depressed more than end surfaces of the first substrate and the second substrate on the side surface.

3. The liquid ejection head according to claim 2, wherein at least one of the first substrate and the second substrate has a junction surface depressed portion that is a depressed portion provided on a junction surface, and the junction surface depressed portion is filled with the junction layer.

4. The liquid ejection head according to claim 3, wherein a relationship between a and β is α22 β, where the α represents a capacity of the junction surface depressed portion and the β represents a capacity of an adhesive between the junction surface depressed portion and the side surface.

5. The liquid ejection head according to claim 3, wherein the plurality of junction surface depressed portions are arranged along a direction of extension of the side surface, and a relationship between α′ and β′ is α′>β′, where the α′ represents a total capacitance of the plurality of junction surface depressed portions, and the β′ represents a capacitance of an adhesive between a straight line connecting the junction surface depressed portions and the side surface.

6. The liquid ejection head according to claim 5, wherein the junction surface depressed portion is disposed on the substrate that faces the pad electrode from among the first substrate and the second substrate.

7. The liquid ejection head according to claim 2, wherein
at least one of the first substrate and the second substrate of the substrates has a step portion having a shape, in which a portion of the side surface thereof is depressed, and provided at a position continuous to the depressed portion,
the step portion is configured to be continuous with the depressed portion, and
the sealing agent is also disposed on the step portion along with the depressed portion.

8. The liquid ejection head according to claim 2, wherein
at least one of the first substrate and the second substrate of the substrates has a protruded portion protruding to the other, and
the depressed portion on the side surface is formed in a gap between the first substrate and the second substrate formed by the protruded portion.

9. The liquid ejection head according to claim 1, wherein in the substrate, the depressed portion is disposed on a side surface corresponding to a side of the substrate on which the pad electrode is disposed.

10. The liquid ejection head according to claim 1, wherein an external wiring substrate having the external wire is joined to the substrate so as to face the pad electrode.

11. A method for manufacturing a liquid ejection head having a substrate and an external wire, the method comprising:
forming a substrate having an ejection port configured to eject a liquid; an energy generating element configured to generate an energy for ejecting the liquid, a liquid inflow port configured to receive supply of the liquid; a pad electrode, an internal wire configured to electrically connect the pad electrode, the energy generating element, and a depressed portion provided on a side surface;
connecting the external wire to the pad electrode of the substrate; and
covering with a sealing agent an electrical connection portion connecting the pad electrode and the external wire, and at least a portion of the side surface of the substrate including the depressed portion.

12. The method for manufacturing a liquid ejection head according to claim 11, further comprising:
preparing a first substrate and a second substrate each constituting the substrate;
forming a modified layer in an inside of the first substrate, the modified layer being formed at a position to be the side surface when the substrate is diced;
joining the first substrate and the second substrate by using a junction layer;
dicing the joined substrates; and
removing the modified layer, thereby forming the depressed portion.

13. The method for manufacturing a liquid ejection head according to claim 12, wherein the modified layer is formed using a laser.

14. The method for manufacturing a liquid ejection head according to claim 12, wherein the forming of the depressed portion includes: forming, in the first substrate, a groove having a depth equal to or greater than that of the modified layer; and removing the modified layer by a chemical treatment.

15. The method for manufacturing a liquid ejection head according to claim 11, further comprising:
preparing a first substrate and a second substrate each constituting the substrate; and
joining the first substrate and the second substrate by using a junction layer;
wherein
the depressed portion on the side surface of the substrate is formed at a position where the junction layer does not exist between the first substrate and the second substrate.

16. The method for manufacturing a liquid ejection head according to claim 15, further comprising: forming a step portion at a position continuous to the depressed portion on the side surface of at least one of the first substrate and the second substrate, wherein
the sealing agent is also disposed on the step portion.

17. The method for manufacturing a liquid ejection head according to claim 15, further comprising: providing, on at least one of the first substrate and the second substrate, a protruded portion protruding toward the other, wherein
the scaling agent is formed in a gap between the first substrate and the second substrate formed by the protruded portion.
